(19) United States
(12) Patent Application Publication
(10) Pub. No.: US 2014/0193270 A1
(43) Pub. Date: Jul. 10, 2014

(54) CERAMIC COMPOSITE MATRIX MATERIAL BONDED ASSEMBLY AND PROCESSES THEREOF

(71) Applicant: COI Ceramics, Inc., San Diego, CA (US)

(72) Inventors: Richard B. Plunkett, San Diego, CA (US); Kourtney R. Buckley, Oceanside, CA (US); Andrew Szweda, San Diego, CA (US)

(21) Appl. No.: 13/736,723

(22) Filed: Jan. 8, 2013

(51) Int. Cl. B29D 99/00; F01D 5/14

(52) U.S. Cl. CPC B29D 99/0025; F01D 5/147
USPC 416/241 R; 156/89.11

(57) ABSTRACT

A method of making multipart assemblies by producing single parts from ceramic composite materials that are machined and bonded together to form the multipart assembly. The method is used to make turbine engine vanes.

### BACKGROUND

The fabrication of complex shapes using continuous fiber reinforced composites generally requires a complicated 2-D fabric ply layup scheme and molding in an autoclave or a 3-D woven fiber preform that is made into a composite using resin transfer molding. For shapes that include very sharp corners or that are small in size, the above mentioned techniques are not viable when using continuous ceramic fibers.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

The invention provides, in one aspect, a method of fabricating a multi-part assembly comprising

applying a ceramic precursor to at least a portion of at least one of a first part and second parts;

converting the ceramic precursor into a ceramic to bond the at least first part to the second part.

The invention provides, in another aspect, a method of forming a turbine vane comprising:

forming an airfoil;

forming a first platform;

forming a second platform;

applying a ceramic precursor to the airfoil between the first and second platform; and

converting the ceramic precursor into a ceramic to bond the airfoil between at least first and second platforms.

The invention provides, in yet another aspect, a turbine vane assembly comprising:

an airfoil;

a first platform;

a second platform; and a ceramic bond coupling the airfoil nested between the two platforms.

### BRIEF DESCRIPTION OF THE DRAWINGS

The present invention can be more easily understood and further advantages and uses thereof will be more readily apparent, when considered in view of the detailed description and the following figures in which:

FIG. 1 is a flow chart illustrating the process according to an embodiment of the invention;

FIG. 2A is a perspective view of parts of a turbine vane including an airfoil and a first and second platform;

FIG. 2B is a perspective view of the vane parts assembled; and

FIG. 3 is a perspective view of a multi-vane assembly.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the invention may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the disclosed process provides for the manufacture of multi-piece composite parts with complex geometries (e.g. curved geometries, variable cross section geometries, geometries with small sizes and dimensions, and the like by fabricating multiple simple geometries which are then machined to the desired shape and size and bonded together to achieve the final desired complex geometry. The disclosed process results in a simpler composite fabrication process including reduced cost for composite-forming tools and the ability to fabricate geometries that are not possible with ceramic fiber 3D preform weaving or 2-D fabric layup techniques.

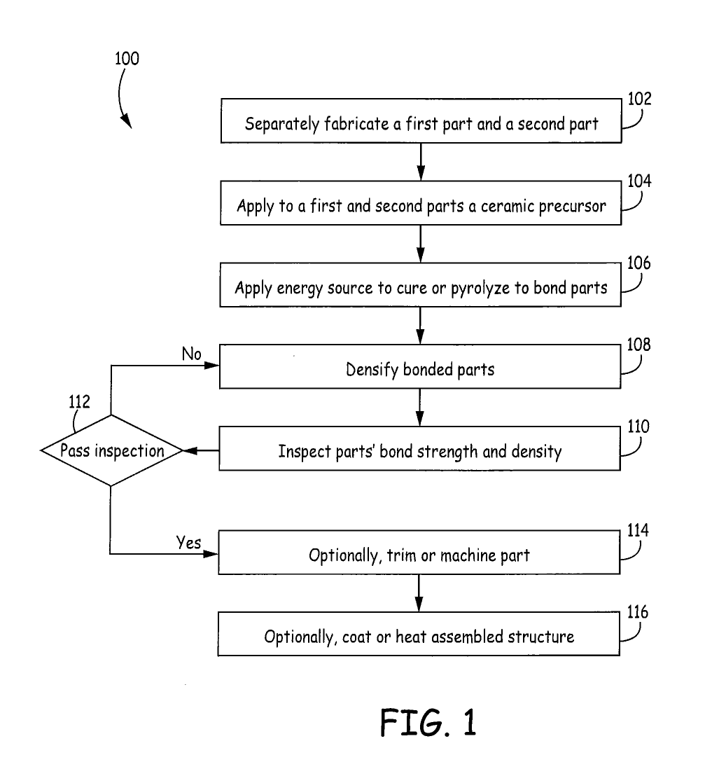

FIG. 1 is a formation flowchart (100) illustrating the manufacturing process according to an embodiment. For example, in an embodiment at least a first part and a second part of a multi-part assembly are separately fabricated (102). The starting materials for the laminate part or parts may be formed from a variety of materials such as prepreg or preform materials. Suitable prepreg materials include carbon fibers woven into fabrics imbedded in a polymer matrix. Exemplary materials are ceramic-based materials, which include homogenous ceramic materials and ceramic matrix composite (CMC) materials. Suitable preform materials include 2-D fabrics or 3-D woven performs available from, for example, Albany International Techniweave Inc. or TEAM.

In other embodiments, non-impregnated fibrous or woven materials (e.g. ceramic or carbon fibers or silicon carbide) may be used with such materials being laid upon on an associated mandrel or placed inside a closed cavity mold.

The materials may include ceramic matrix composites that include ceramic fibers embedded in a ceramic matrix. In some embodiments, laminate structure or part may be partially cured such that the laminate part may be subsequently co-cured with an associated composite part at a later time. In one embodiment, the materials include ceramic composite materials such as continuous fiber reinforced composites, non-oxide ceramic matrix composites, and the like and combinations thereof.

The separate parts of a multi-part assembly may be formed or fabricated by any known method. For example, a laminate part may be formed by stacking composite plies over a mold, mandrel or other similar tool to form a first laminate part. Stacking may be by hand or by a manual or automated process. After a few plies are laid up, the laminate part may need to be compacted or debulked. This is conventionally accomplished by vacuum debulking wherein a vacuum bag is placed over the laminate part and a vacuum applied to the part by way of the bag. Often, heat may be applied to assist in the debulking process and in an attempt to further compact the laminate part. In forming the laminate part, multiple vacuum compactions may need to take place upon the building up of layers to form the laminate part.

In one embodiment, the formation of a first laminate part or structure may be conducted on a ply-by-ply basis. In other words, formation of the first laminate structure or part may be effected by shaping a first ply to the desired cross-sectional geometry, applying a second ply of material and shaping the second ply of material to the desired cross-sectional geometry and conformally with the first shaped ply. Shaping and debulking of laminate structure or part may be achieved as a substantially continuous and interrelated process. The laminates may be trimmed Trimming may also be conducted simultaneously as the plies are being laid up. Trimming may be achieved with, for example, a knife, a rolling blade, a laser, or other appropriate trimming means.

In another embodiment, multiple plies may be placed over a mandrel and shaped to a desired cross-sectional geometry simultaneously while also being consolidated and debulked, followed by placement of two, three or more material plies.

In some embodiments, the laminated part or parts may be formed as relatively complex shapes, not only with respect to their cross-sectional geometries, but also with respect to their geometries along a defined longitudinal axis. For example, turbine vanes may be slightly swept, highly swept or twisted or some combination. Additionally, it is noted that the individual material plies may be configured to exhibit substantially any desired fiber orientation (or orientations) as may be needed in accordance with expected loadings and stress states of the laminate part. Thus, for example, a first ply may be formed of a material exhibiting a 0° fiber orientation; a second ply may include material exhibiting a 45° fiber orientation and so on. Other fiber orientations and other ply configurations may be used.

The laminate parts may be formed by suitable molding methods for a composite material such as compression molding, autoclave, vacuum bag, pultrusion, resin transfer molding, filament winding, sheet molding, bulk molding and the like.

After different parts (e.g. at least a first part and at least a second part) of a multi-part article are formed by the process discussed above, the multi-part may be attached or bonded together by methods such as curing, pyrolyzing, chemical vapor deposition (CVD) and the like. Briefly, a ceramic precursor or any other material or substance that may be converted into a ceramic after processing may be applied to a surface of at least the first part and at least a second part (104) using any suitable application method such as painting, spraying, dipping or infiltration into a matrix. After applying the ceramic precursor to the appropriate part surface, the part may be subjected to an energy source such as in an autoclave, oven or microwave to cure the precursor. In a subsequent operation or in lieu of curing, other energy sources may be use such as vacuum oven sufficient to convert the precursor to a ceramic (106). This pyrolysis process may be carried out at a temperature from about 800° C. and higher, for about one hour to two hours or for a time sufficient to bond the various parts. The process may take place under substantially inert gas (e.g. argon or nitrogen). In other embodiments, individual ceramic parts can be joined by placing the assembled parts in a chemical vapor deposition chamber and coating the assembly with a layer of ceramic. If desired, the laminates may also be machined or molded to include mechanical interlocking features to increase surface area and enhance bonding.

Densification of the bond line or pyrolyzed assembly (108) is conventionally accomplished by polymer infiltration and pyrolysis or chemical vapor infiltration. Such energy source results in converting the ceramic precursor into ceramic, which in turn results in bonding the first part to the second part (108). Because the energy application may result in voids or material shrinkage, the parts are inspected, for example, the bond strength and the density and open porosity (110). If the bond lines need further strengthening or the assembly needs further density, multiple cycles of applying the ceramic precursor, curing and pyrolysis may be carried out (112). For example, fiber-reinforced ceramic matrix composites may be formed by PIP with the reinforcement material including continuous fibers. Infiltration may be achieved by vacuum, or pressure at ambient conditions. Once a suitable bond strength and density and open porosity is achieved, the bonded assembly may be trimmed or machined to the desired shape or geometry (114).

The ceramic precursors may include monomers, oligomers or polymers. Suitable ceramic precursors include, for example, polysilazanes, hydridopolysilazanes, polysiloxanes, borosilizanes, polyureasilazanes, polythioureasilazanes, polycarbosilanes, polysilanes, polysiloxanes, polyborosilazanes, polyaminosilazanes, polyaminoboranes, polyalazanes, polyborazanes and the like. Precursors to oxide ceramics such as aluminum oxide as well as non-oxide ceramics can also be used. Ceramic precursors may have char yields in excess of 20 percent by weight, in excess of 40 percent by weight, in excess of 50 percent by weight when the hardened precursor is thermally decomposed.

After the multipart product is assembled, and if required, trimmed into its desired product. The assembled part or structure may be optionally coated with an environmental barrier by methods known in the art (116). An environmental barrier coating (EBC) is a coating that provides protection to the underlying product or part against selected environments such as temperature, corrosion and the like. Exemplary EBCs include those produced from combinations of ceramic fillers, such as silicon carbide, silicon nitride, boron carbide, hafnium diboride, hafnium carbide or combinations thereof. Other EBC's including coatings of mullite, calcium aluminum silicate, lithium aluminum silicate and strontium aluminum silicate, or combinations thereof.

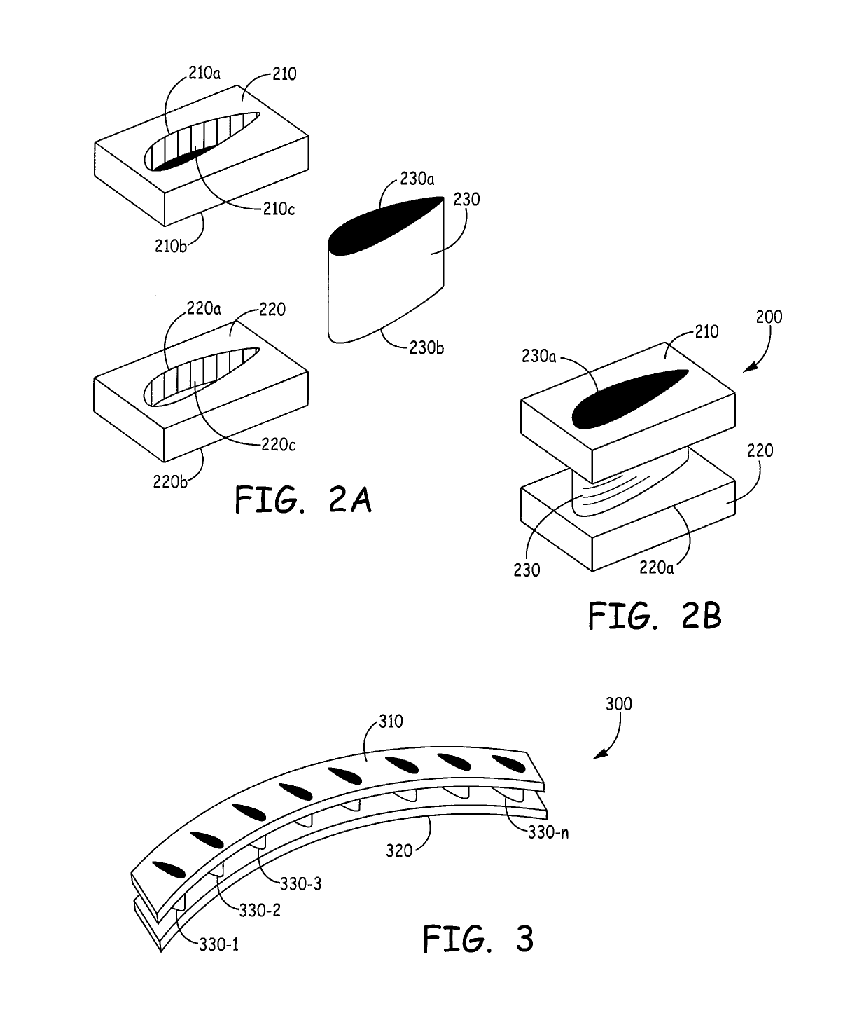

In one embodiment, the disclosed process may be applied to assemble a turbine engine guide vane. As illustrated in FIG. 2A, each vane 200 includes a first platform 210 and a second platform 220 and an air foil 230 disposed between the first and second platforms.

As shown in FIG. 2A, first platform 210 has a top surface 210a and a bottom surface 210b with a recess 210c formed on the top surface 210a of the first platform 210. The recess 210c has the same shape as the airfoil 230 but is slightly larger to accommodate the airfoil and bondline. The second platform 220 has a top surface 220a, a bottom surface 220b with a recess 220c formed on the top surface 220a of the second platform 220. The recess 220c has the same shape as the airfoil 230 but is slightly larger to accommodate the airfoil 230 and bondline. Airfoil 230 also has a top surface 230a and a bottom surface 230b. This arrangement allows the top portion 230a of airfoil 230 and bottom portion of airfoil 230b to nest within the respective first platform 210 and second platform 220, as depicted in FIG. 2B. In some embodiments, multiple vanes 200 may be assembled to form various configurations (e.g. circular or the like) by bonding each vane 200 by the disclosed process.

A ceramic adhesive or a ceramic precursor is applied to the faying surfaces of the three components 230, 210 and 220 followed by application of an energy source. The application of energy converts the ceramic precursor to ceramic which results in bonding the three parts. Additional application of a ceramic precursor followed by an energy source can be performed on the assembly to further strengthen and densify the bond lines and materials. If required, machining or trimming can then be performed to achieve the final desired shape. Platforms and airfoil may be machined from 2D or 3D formed laminates, or airfoil could be formed from a 3D woven shape. The airfoil portion may be solid or hollow for reduced weight.

It will be appreciated that since the vane is assembled by bonding the multi-parts, it is possible to form the vane from different materials. It will also be appreciated that a plurality of airfoils 330, and as illustrated in FIG. 3, may be disposed between a first platform 310 and second platform 320 in which the platforms may be machined to include a plurality of recesses to allow a plurality of air foils 330-1, 330-2 . . . 330-n) to nest between the first platform 310 and second platform 320. The disclosed process may also be applied to other airfoils used in turbo-machines such as those in stationary vanes in the compressor portion of the gas or steam turbines or part that is considered having a small dimension. Such dimensions include, but are not limited to, an inch by inch on end and an inch tall, including vanes for larger gas turbines, for example up to nine inches tall.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of fabricating a multi-part assembly comprising
applying a ceramic precursor to at least a portion of at least one of a first part and second parts;
converting the ceramic precursor into a ceramic to bond the at least first part to the second part.

2. The method of claim 1, further comprising forming the at least first part and the at least second parts.

3. The method of claim 1, wherein the forming the at least one of the first part and second part further comprises using impregnated material to form the at least one of the first part and second part.

4. The method of claim 1, wherein the forming of at least one of the first part and second part is from a ceramic matrix composite.

5. The method of claim 1, wherein the forming of at least one of the first part and second part is from a 2-D or 3D woven preform or combinations thereof.

6. The method of claim 1, wherein the forming of at least one of the first part and second part is from a non-oxide ceramic matrix composite.

7. The method of claim 1, wherein at least one of the first and second part has a cross-sectional geometry that varies along the length, wherein at least one of the first part and second part has continuous fibers.

8. The method of claim 1, wherein the ceramic precursor is at least one of polysilazanes, hydridopolysilazanes, polysiloxanes or borosilizanes.

9. The method of claim 1, wherein the applying the ceramic precursor to the at least one of the first part and second part further comprises applying the ceramic precursor to a faying surface of the part to be bonded.

10. The method of claim 1, wherein the applying is by infiltrating the ceramic precursor into the parts.

11. The method of claim 1, wherein the converting the ceramic precursor is by pyrolysis.

12. The method of claim 1, further comprising forming at least a portion of a turbine vane with the at least one first part and the at least one second part.

13. A method of forming a turbine vane comprising:
forming an airfoil;
forming a first platform;
forming a second platform;
applying a ceramic precursor to the airfoil between the first and second platform; and
converting the ceramic precursor into a ceramic to bond the airfoil between the at least first and second platforms.

14. The method of claim 13, wherein the forming is from a ceramic composite material.

15. The method of claim 13 wherein the vane comprises a plurality of airfoils disposed between the first and second platforms.

16. A turbine vane assembly comprising:
an airfoil;
a first platform;
a second platform; and a ceramic bond coupling the airfoil nested between the two platforms.

17. The assembly of claim 16 wherein the airfoil, first and second platform are a ceramic matrix composite.

18. The assembly of claim 16, wherein the airfoil is hollow or solid member.

19. The assembly of claim 16, wherein the assembly comprises a plurality of airfoils nested between the first and second platforms.
